(19) United States
(12) Patent Application Publication
(10) Pub. No.: US 2012/0096385 A1
(43) Pub. Date: Apr. 19, 2012

(54) MANAGING THE SCHEDULING OF EVENTS

(75) Inventors: Judith Helen Bank, Morrisville, NC (US); Lisa Marie Wood Bradley, Cary, NC (US); Jason Michael Brown, Cary, NC (US); Dana Lea Price, Cary, NC (US)

(73) Assignee: INTERNATIONAL BUSINESS MACHINES CORPORATION, Armonk, NY (US)

(21) Appl. No.: 12/907,180

(22) Filed: Oct. 19, 2010

(51) Int. Cl. G06F 3/048

(52) U.S. Cl. 715/772

(57) ABSTRACT

A method for managing scheduling of events includes receiving a constraint for a type of event and limiting scheduling of the type of event based on the constraint for the type of event. A computerized event management system includes a processor and a memory communicatively coupled to the processor. The processor is configured to have a constraint for a type of event and limit the scheduling of the type of event based on the constraint for the type of event.

### BACKGROUND

Aspects of the present invention relate in general to applications and solutions for managing the scheduling of events, and more particularly, to a system and method for limiting the scheduling of events belonging to a predefined type of event.

Many people make use of computerized event management systems to help manage their busy schedules. These computerized event management systems allow a user to schedule several events throughout his or her day, week, and month. The user may then refer to this created schedule to make sure that he or she is present at the many events that he or she has scheduled.

Users of such event management systems may often perceive that they spend too much time on one type of event while not spending enough time on another type of event. For example, a business manager may perceive that he or she spends too much time holding training meetings and not enough time holding one-on-one meetings with his or her employees.

### BRIEF SUMMARY

A method for managing the scheduling of events performed by a computerized event management system includes, with the computerized event management system, receiving a constraint for a type of event; and with the computerized event management system, limiting scheduling of that type of event based on the constraint.

A computerized event management system includes a processor and a memory communicatively coupled to the processor. The processor is configured to have a constraint for a type of event; and limit scheduling of that type of event based on the constraint.

A computer program product for event management, the computer program product includes a computer readable storage medium having computer readable code embodied therewith, the computer readable program code includes computer readable program code configured to recognize a constraint for a type of event; and computer readable program code configured to limit scheduling of that type of event based on the constraint.

### BRIEF DESCRIPTION OF THE SEVERAL VIEWS OF THE DRAWINGS

The accompanying drawings illustrate various embodiments of the principles described herein and are a part of the specification. The illustrated embodiments are merely examples and do not limit the scope of the claims.

FIG. 1 is a diagram showing an illustrative physical computing system, according to one embodiment of principles described herein.

FIG. 2 is a diagram of an illustrative event constraints, according to one embodiment of principles described herein.

FIG. 3 is a diagram showing an illustrative schedule, according to one embodiment of principles described herein.

FIG. 4 is a diagram showing an illustrative network which may be used by an event management system, according to one embodiment of principles described herein.

FIG. 5 is a diagram showing an illustrative user interface which may be used by an event management system, according to one embodiment of principles described herein.

FIG. 6 is a flowchart showing an illustrative method for limiting scheduled events, according to one embodiment of principles described herein.

Throughout the drawings, identical reference numbers designate similar, but not necessarily identical, elements.

### DETAILED DESCRIPTION

The present specification discloses methods and systems for allowing users of computerized event management systems to place constraints on the allotted time for events of a particular type. For example, the different events scheduled by a user may be classified into different types, either by the user or automatically based on information received or accessible about the event. A constraint may then be placed as to how much time or how many of a particular type of event can be scheduled within a particular period of time window. For example, a business manager may place a constraint on the hours spent holding training meetings within a week as well as a constraint placed on the hours spent holding one-on-one meetings during the week.

When attempting to schedule an event that exceeds the associated constraint for that type of event, the system may inform the user that scheduling the present event will exceed the constraint, for example, by a particular amount of time or exceed an allotted number of such events permitted in the time window. The user may then decide whether or not to schedule the new event. Additionally, when a user is in the process of scheduling an event of a particular type, the user may be given information as to the remaining amount of allotted time instances permitted for that particular type of event.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

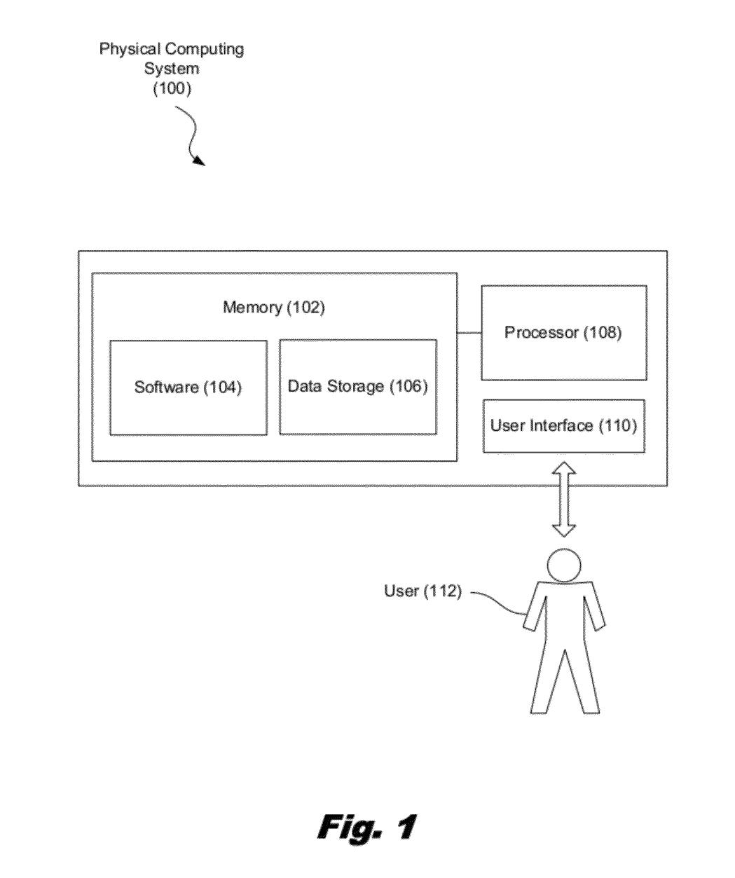

Referring now to the figures, FIG. 1 is a diagram showing an illustrative physical computing system (100) which may be used to place constraints on the different types of events within a user's schedule. According to certain illustrative embodiments, the physical computing system (100) may include a memory (102) having software (104) and data (106) stored thereon. As described below, this software (104) will include a time or event management system with event scheduling based on constraints, such as the total amount of time allocated for a particular type of event or a limit on the amount of a type of event that may be scheduled within a given time window.

There are many types of memory available. Some types of memory, such as hard disk drives, optical disc drives, and solid state drives, are designed for storage. These types of memory typically have large storage volume but relatively slow performance. Other types of memory, such as those used for Random Access Memory (RAM), are optimized for speed and are often referred to as “working memory.” The various forms of memory may store information in the form of software (104) and data (106).

The physical computing system (100) also includes a processor (108) for executing the software (104) and using or updating the data (106) in the memory (102). The physical computing system (100) may be embodied as a variety of physical computing devices including, but not limited to, a laptop or tablet computer, a desktop computer, and a Personal Digital Assistant (PDA) or mobile smart phone.

Various types of software (104) may be utilized by the physical computing system (100). For example, one type of software which may be stored in memory is event management software. The event management software is a program configured to assist a user (112) with the task of managing his or her event schedule. The event management software may be configured to interface with event management software on the computing systems of other users to facilitate the scheduling of meetings among those users.

A user interface (110) may provide a means for the user (112) to interact with the computing system (100). The user interface may include any collection of devices for interfacing with a human user (112). For example, the user interface (110) may include an output component such as a display device and input components such as a mouse or keyboard. Information associated with calendar entries, including meeting entries, may be displayed to the user (112) on a display device of the user interface (110). Instructions from the user to the physical computing system (100) may be received through the input devices of the user interface (110).

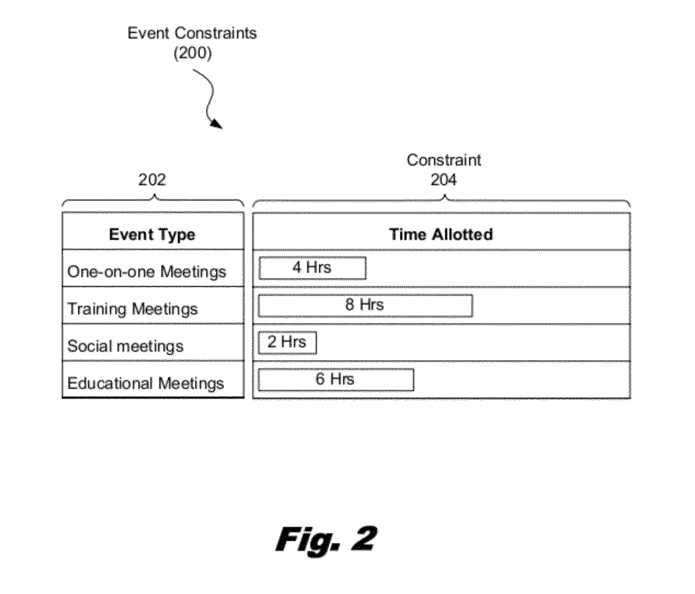

FIG. 2 is a diagram showing illustrative event constraints (200). As mentioned above, a user may feel that he or she spends too much time engaged in a particular type of event. Additionally or alternatively, a user may feel that he or she does not spend enough time engaged in a particular type of event. According to certain illustrative embodiments, a user can categorize his or her events based on the characteristics of those events. The user can then place constraints on each type of event. One type of constraint that a user can place on a type of event is a time limit on that type of event within a predefined time window. For example, the user can specify that he or she wants to spend at most four hours a week engaged in a particular type of event.

FIG. 2 illustrates an example of four different event types (202). These event type examples include, one-on-one meetings, training meetings, social meetings, and educational meetings. Each of these types of events is associated with a constraint (204). Particularly, each event is associated with an allotted amount of time. For example, one-on-one meetings are limited to four hours per week, training meetings are limited to eight hours per week, social meetings are limited to two hours per week, and educational meetings are limited to six hours per week.

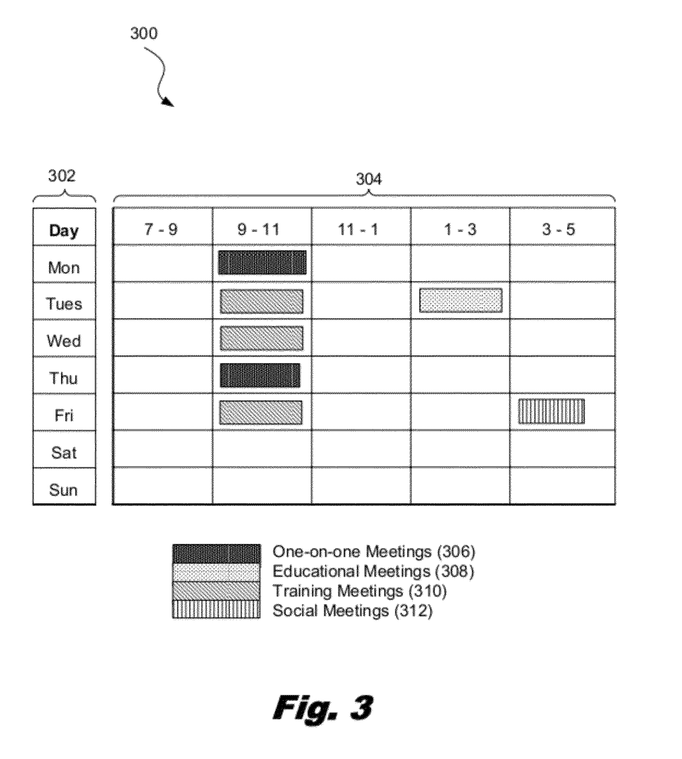

FIG. 3 is a diagram showing an illustrative schedule (300). According to certain illustrative examples, the event management system can display events that have already been scheduled. In the example illustrated in FIG. 3, the days (302) within a week are represented as rows and the times (304) throughout a day are represented by columns. These events can be labeled or color coded based on the category in which that type of event has been placed.

When scheduling events of a particular type, the event management system can check to see if scheduling that event will violate a constraint. For example, if the user wishes to schedule a one hour long one-on-one meeting (306), the user will be warned by the event management system that to do so would violate the constraint of only allowing four hours of this type of event per week. This is because four hours of one-on-one meetings (306) have already been scheduled. If a user wishes to schedule a one hour long educational meeting (308), doing so will not violate the constraint of allowing only six hours of educational meetings (308). This is because only two hours have previously been scheduled.

In some examples, the event management system can display to a user, the remaining time allowed for a particular type of event. For example, if the user desires to schedule a training meeting (310), the event management system can inform the user that six out of the eight allotted hours have already been scheduled. The user can then know that he or she should not schedule a training meeting (310) longer than two hours.

In some examples, a constraint can be the number of events of a particular type rather than the total amount of time spent on one type of event. For example, a constraint can be that only one social meeting (312) is allowed per week. In this case, if a user attempts to schedule a social meeting (312), the event management system can inform the user that he or she already has a social event scheduled for this week.

In some cases, the user may have the option of disregarding the constraints and scheduling an event as desired. In such examples, the constraint provides a guideline or advisory to help the user better manage the distribution of his or her time among different types of activities without imposing such structure on the user's schedule.

In other cases, the system may impose the constraints on the user without an option to easily ignore the constraint. For example, an employer may place a constraint on an employee's schedule. In this type of case, the employee-user may not have the option of disregarding a constraint when being informed that an attempted scheduling of an event violates that constraint.

In some examples of the principles disclosed, a user may specify a constraint that includes a percentage of time. For example, a user may say that only ten percent of his or her work time should be dedicated to meetings of a specific type. As the user changes his or her work schedule, the hours which are allotted for that specific type may change while the percentage of total work hours stays the same.

When entering an event into the system, the user may specify the type of the event. The system may prompt the user for this information. The system may include a menu listing the types of events that have been established within the system from which the user can select the correct type for the event in question.

The system will also allow the user to define any number of event types and any defining characteristics associated with each event type, as described below. In some instances, the system may be preprogrammed with some general event types and typical characteristics of those event types.

Where an event type is associated with one or more defining characteristics, an event may be classified as a particular type of event automatically. This may be done by matching the defining characteristic(s) of an event type with the characteristics of an event to be scheduled.

For example, a user may assign a title to the event to be scheduled. The event management system can parse the words in the title and determine if certain keywords indicating event type are present. If a keyword is present, then the event management system can classify that event based on the event type associated with that keyword.

Additionally, if a user typically classifies an event within a particular time frame as a particular type of event, then the event management system may automatically classify events scheduled by the user during that time frame. For example, if a user typically only schedules social meetings (312) after 4:00 PM, then the event management system can automatically classify any event scheduled after 4:00 PM as a social meeting type of event.

The user may also have the option to manually reclassify an automatic classification of an event. This may be done with a menu showing the types of events that have been established within the system from which the user can select the correct type for the event in question.

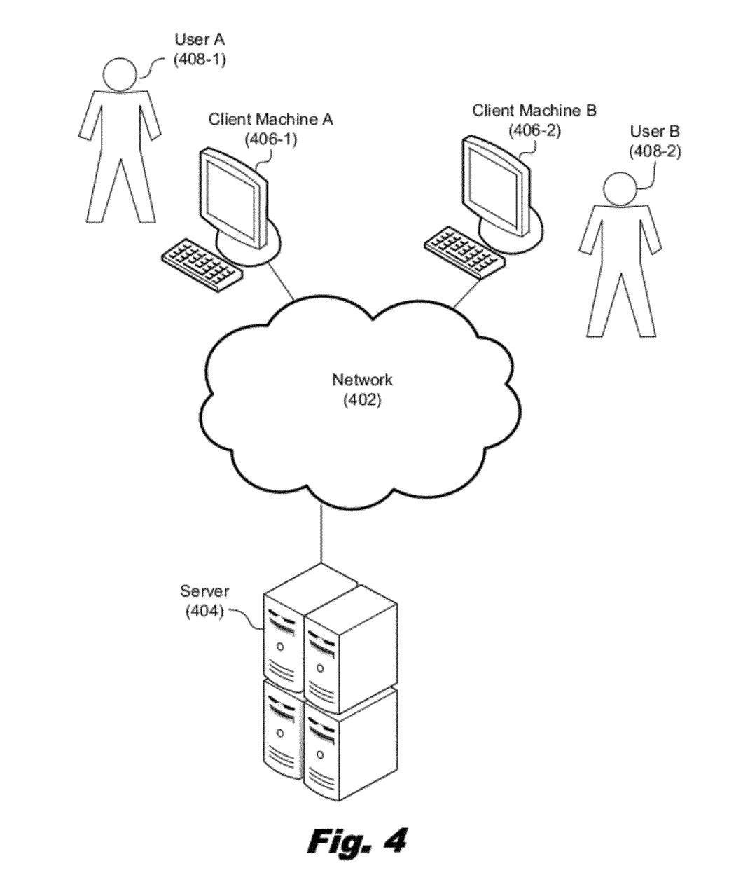

FIG. 4 is a diagram showing an illustrative network (402) which may be used by an event management system. According to certain illustrative examples, an event management application may operate as a network application. The network application may be stored on a server (404). An event management application running on one client machine (406-1) may also interact with an event management application running on a different client machine (406-2).

For example, if user A (408-1) schedules a meeting involving user A (408-1) and user B (408-2), then when user A (408-1) uses client machine A (406-1) to schedule the meeting, that meeting will be viewable by user B (408-2) through client machine B (406-2). In the case that the meeting violates a constraint for user B's (406-2) event management application, user A (408-1) can be warned that scheduling that event will violate user B's (408-2) event constraints. User A (408-1) may then decide whether or not to continue to schedule the event.

Depending on the relationship between user A (408-1) and user B (408-2), the event management system may or may not allow user A (408-1) to override user B's (408-2) event constraints. For example, if user A (408-1) is user B's (408-2) manager, then user A (408-1) might have overriding privileges.

In some cases, when a user receives an event invitation of a particular type, the user may be provided with statistics as to how much time left the user has available for that type of event. For example, if user A (408-1) sends an event invitation to user B (408-2) for a training meeting type of event, then user B's (408-2) client machine (406-2) can provide user B with the current statistics for training meeting type of events. User B (408-2) may then decide whether or not to accept the invitation based, at least in part, on the statistics provided regarding that type of event in User B's schedule.

In some cases, an event which is scheduled by another user may be assigned an event type automatically based on who scheduled the event. Particularly, if an event scheduled by user A (408-1) includes both user A (408-1) and user B (408-2), the event may be automatically assigned an event type in user B's event management application based on the fact that the event was scheduled by user A (408-1). For example, if user A (408-1) has a training role within a company, then user B's (408-2) event management application can determine that the event scheduled by user A (408-1) is a training meeting. Therefore, the scheduled event can be classified as such.

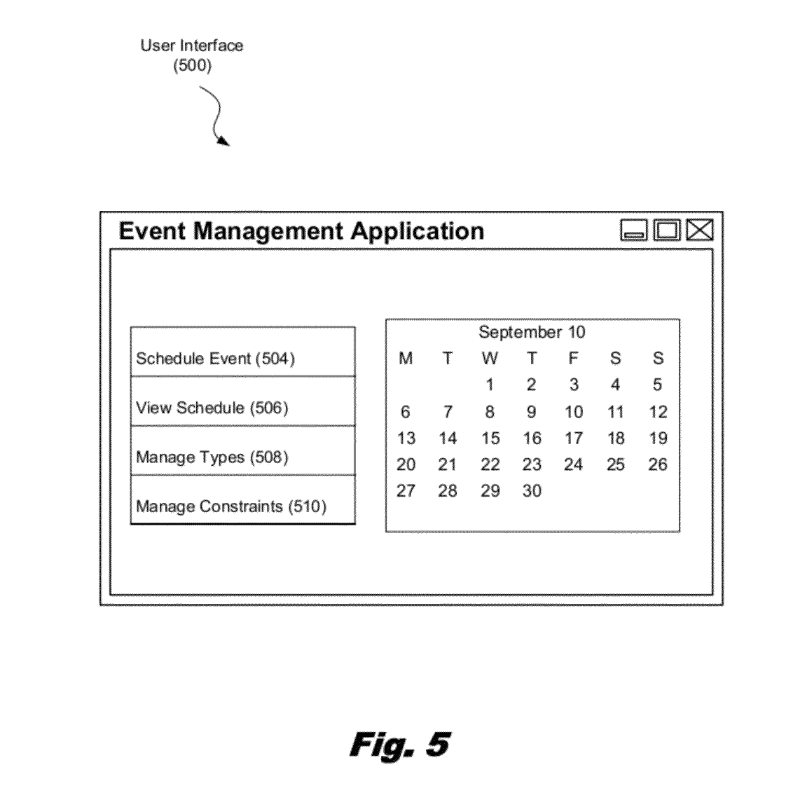

FIG. 5 is a diagram showing an illustrative user interface (500) which may be used by an event management system. According to certain illustrative examples, the user interface (500) can include controls which allow a user to schedule (504) an event, view (506) scheduled events, manage (508) types, and manage (510) constraints. The user interface (500) described herein is for illustrative purposes only and does not necessarily indicate the appearance of a practical user interface for a method or system embodying principles described herein.

The “schedule event” control (504) can allow a user to schedule a new event. When scheduling a new event, a user may manually classify the event. In some cases, as mentioned above, the event can be automatically classified based on characteristics of the event. The “view event” control (506) can allow a user to view the events which have already been scheduled by that user or other users.

The “manage types” control (508) can allow a user to manage the various event types which can be assigned to a scheduled event. For example, the user may create or modify event types and indicate what kind of events should be included in a particular event type. If the event management application is set to automatically determine an event type for a scheduled event based on keywords within the title of that event, the user may specify which keywords should be assigned to a particular event type.

The “manage constraints” control (510) can allow a user to manage the various types of constraints which may be placed on particular event types. For example, a user may limit a particular type of event to 4 hours per week. Alternatively a user may limit a particular type of event to 15 hours per month. In the case that the user wishes to limit events by number rather than total time, the user can also set such constraints by using the “manage constraints” control (510).

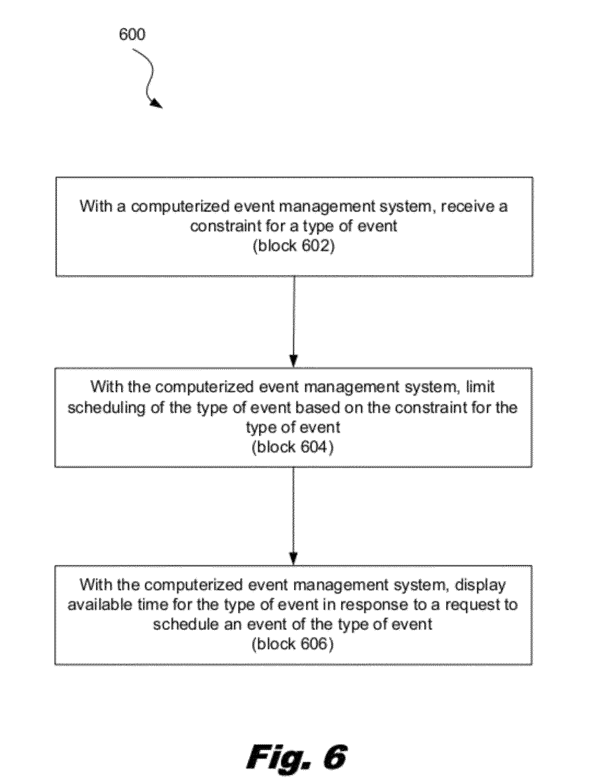

FIG. 6 is a flowchart showing an illustrative method for limiting scheduled events. According to certain illustrative embodiments, the method includes, with a computerized event management system, receiving or recognizing (block 602) a constraint for a type of event, with the computerized event management system, limiting (block 604) scheduling of the type of event based on the constraint, and with the computerized event management system, displaying (block 606) available time for the type of event in response to a request to schedule an event of that type.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method for managing scheduling of events performed by a computerized event management system, the method comprising:
with said computerized event management system, receiving a constraint for a type of event; and
with said computerized event management system, limiting scheduling of said type of event based on said constraint.

2. The method of claim 1, in which said constraint comprises an allowed total amount of time within a specified time window.

3. The method of claim 2, further comprising, with said computerized event management system, displaying remaining time available for said type of event in response to a request to schedule an event of said type of event.

4. The method of claim 1, in which said constraint comprises an allowed number of events of said type within a specified time window.

5. The method of claim 1, in which said constraint for said type of event is manually preset by a user of said computerized event management system.

6. The method of claim 1, in which said event type is specified by a user of said computerized event management system.

7. The method of claim 1, in which said event type is specified by an organization associated with a network used by said computerized calendar event system.

8. The method of claim 1, further comprising, with said computerized event management system, automatically assigning an event type to an event based on a characteristic of said event.

9. The method of claim 8 in which said characteristic comprises a title given to said event.

10. The method of claim 8, in which said characteristic comprises an entity associated with said event.

11. A computerized event management system comprising:
a processor; and
a memory communicatively coupled to said processor;
in which said processor is configured to:
have a constraint for a type of event; and
limit scheduling of said type of event based on said constraint.

12. The system of claim 11, in which said constraint comprises an allowed total amount of time within a specified time window.

13. The system of claim 12, in which said processor is further configured to display available time for said type of event in response to a request to schedule an event of said type of event.

14. The system of claim 11, in which said constraint comprises an allowed number of events within a specified time window.

15. The system of claim 11, in which said allowed amount of time within said time window for said type of event is preset by a user of said computerized event management system.

16. The system of claim 11, in which said event type is specified by a user of said computerized event management system.

17. The system of claim 11, in which said event type is specified by an organization associated with a network used by said computerized calendar event system.

18. The system of claim 11, in which said processor is further configured to automatically assign an event to an event type based on a characteristic of said event.

19. The system of claim 11, in which said characteristic comprises at least one of: a title given to said event and an entity associated with said event.

20. A computer program product for event management, said computer program product comprising:
a computer readable storage medium having computer readable code embodied therewith, said computer readable program code comprising:
computer readable program code configured to recognize a constraint for a type of event; and
computer readable program code configured to limit scheduling of said type of event based on said constraint.
